(19) United States
(12) Patent Application Publication
(10) Pub. No.: US 2014/0040561 A1
(43) Pub. Date: Feb. 6, 2014

(54) HANDLING CACHE WRITE-BACK AND CACHE EVICTION FOR CACHE COHERENCE

(71) Applicant: Futurewei Technologies, Inc., Plano, TX (US)

(72) Inventors: Iulin Lih, San Jose, CA (US); Chenghong He, Shenzhen (CN); Hongbo Shi, Xian (CN); Naxin Zhang, Singapore (SG)

(21) Appl. No.: 13/900,187

(22) Filed: May 22, 2013

Related U.S. Application Data
(60) Provisional application No. 61/677,905, filed on Jul. 31, 2012.
(60) Provisional application No. 61/780,494, filed on Mar. 13, 2013.

(51) Int. Cl. G06F 12/08

(52) U.S. Cl. CPC G06F 12/0891; G06F 12/0831
USPC 711/135; 711/146

(57) ABSTRACT

A method implemented by a computer system comprising a first memory agent and a second memory agent coupled to the first memory agent, wherein the second memory agent has access to a cache comprising a cache line, the method comprising changing a state of the cache line by the second memory agent, and sending a non-snoop message from the second memory agent to the first memory agent via a communication channel assigned to snoop responses, wherein the non-snoop message informs the first memory agent of the state change of the cache line.

### CROSS-REFERENCE TO RELATED APPLICATIONS

The present application claims priority to U.S. Provisional Patent Application No. 61/677,905 filed Jul. 31, 2012 by Iulin Lih et al. and entitled “Handling Cache Write-back and Cache Eviction for Cache Coherence” and U.S. Provisional Patent Application No. 61/780,494 filed Mar. 13, 2013 by Iulin Lih et al. and entitled “Handling Cache Write-back and Cache Eviction for Cache Coherence,” both of which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

As clock speeds for processors increase and main memory becomes larger, longer latency periods may occur when a processor accesses main memory. Cache hierarchies (e.g. different cache levels) may be implemented to reduce latency and performance bottlenecks caused by frequent access to main memory. Cache may be one or more small high speed associative memories that reduce the average time to access main memory. To reduce the average time to access main memory, cache provides a copy of frequently referenced main memory locations. When a processor reads or writes a location in main memory, the processor first checks to see if a copy of the data already resides in the cache memory. When present, the processor is directed to the cache memory rather than the slower main memory. For cache to be effective, a processor needs to continually access the cache rather than main memory. Unfortunately, the size of cache is typically smaller and limited to storing a smaller subset of the data within the main memory. The size limitation may inherently limit the “hit” rate within the cache. A “hit” occurs when the cache holds a valid copy of the data requested by the processor, while a “miss” occurs when the cache does not hold a valid copy of the requested data. When a “miss” occurs within the cache, the processor may subsequently access the slower main memory.

In particular, in a multi-processor computer system, there may be a main memory shared by all processors and a separate cache memory for each of the processors or processing cores. Thus, it is possible to have many copies of any one instruction or data: one copy in the main memory and one in each of the cache memories. In this case, when one copy of data or instruction is changed, the other copies should also be changed to maintain coherence. Cache coherence protocols may help ensure that changes in shared data or instruction are propagated throughout the system in a timely fashion. For example, when the computer system writes a block of data to a cache, it needs to write that block of data back to the main memory at some point. The timing of this write is controlled by a write policy, which may be a write-through policy or write-back policy.

When a state of a cache line in a cache is changed (e.g., data in the cache line needs to be evicted or replaced by new data) by a cache agent (CA), the updated data may need to be written back to the main memory by a home agent (HA). Multiple rounds of message exchanges may be needed between a CA and a HA to complete a coherent transaction, some of which may not always be necessary. For example, a conventional write-back transaction may include a handshake procedure including completion and acknowledgement messages. Since the handshake is implemented after the write-back is already done, it may add unnecessary traffic overhead to the system. In addition, regardless of different properties of certain messages such as cache line request and write-back or eviction messages, conventional transactions may transmit these messages via a same request channel, which may lead to potential deadlock issues and overloading of the HA. Thus, it is desirable to simplify cache coherence transactions to reduce system traffic, while improving system performance.

### SUMMARY

In one embodiment, the disclosure includes a method implemented by a computer system comprising a first memory agent and a second memory agent coupled to the first memory agent, wherein the second memory agent has access to a cache comprising a cache line, the method comprising changing a state of the cache line by the second memory agent, and sending a non-snoop message from the second memory agent to the first memory agent via a communication channel assigned to snoop responses, wherein the non-snoop message informs the first memory agent of the state change of the cache line.

In another embodiment, the disclosure includes an apparatus comprising a first memory agent, and a second memory agent coupled to the first memory agent and configured to change a state of a cache line accessible to the second memory agent, and send a non-snoop message to the first memory agent via a communication channel assigned to snoop responses, wherein the non-snoop message informs the first memory agent of the state change of the cache line.

In yet another embodiment, the disclosure includes a method implemented by a computer system comprising a HA and at least one CA, wherein the at least one CA comprises a CA having access to a cache comprising a cache line, the method comprising changing a state of the cache line by the CA, and sending either a write-back message comprising data stored in the cache line or an eviction message from the CA to the HA, wherein, in a transaction comprising the state change and sending the write-back or eviction message, no handshake is performed between the HA and the CA following the write-back or eviction message.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a memory system.

FIG. 2 illustrates an embodiment of a coherence domain implementation.

FIG. 3A illustrates an embodiment of a cache coherent write transaction.

FIG. 3B illustrates an embodiment of a cache coherent read transaction.

FIG. 4A illustrates an embodiment of a cache coherent write-back transaction.

FIG. 4B illustrates an embodiment of a cache coherent eviction transaction.

FIG. 5 illustrates an embodiment of a cache coherent message handling method.

FIG. 6 illustrates an embodiment of a computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

A cache memory (in short as cache) may typically comprise a plurality of cache lines, which serve as basic units or blocks of data access including read and write accesses. A cache line may comprise data as well as a state. For example, there may be two flag bits per cache line or cache row entry: a valid bit and a dirty bit. The valid bit indicates whether the cache line is valid, and the dirty bit indicates whether the cache line has been changed since it was last read from a main memory. If the cache line has been unchanged since it was last read from a main memory, the cache line is “clean”; otherwise if a processor has written new data to the cache line, and the new data has not yet made it all the way to a main memory, the cache line is “dirty”.

Depending on the protocol, the state of a cache line may be described using various terms. For example, a MESI protocol defines the states of Modified, Exclusive, Shared, and Invalid. According to the MESI protocol, a cache line is in a modified (M) state when the cache line is present only in the current cache, and is dirty (i.e., the cache line has been modified from the value in main memory). The cache may need to write the data back to the main memory sometime in the future, before permitting any other read of the corresponding address in the main memory (now invalid). A write-back may change the cache line to the exclusive state. A cache line is in an exclusive (E) state when the cache line is present only in the current cache, and is clean (i.e., data in the cache matches main memory). The cache line may be changed to the S state at any time, in response to a read request. Alternatively, it may be changed to the M state when being written to. A cache line is in a shared (S) state when the cache line may be stored in another cache or caches of the memory system, and is clean (i.e., data in the cache matches main memory). The cache line may be discarded by changing to the I state at any time. An invalid (I) state indicates that the cache line is invalid or unused. Although MESI is used as an example, it should be understood that any protocol of states may be used within the scope of the present disclosure.

A cache line request may refer to a message from a CA to another memory agent (a HA or a CA), due to an internal event. For example, the cache line request may be a read request or a write request from the CA to the other memory agent, responding to a read or write miss in a cache of the CA, to ask for cache line data and/or permission to read or write. A write-back message (sometimes referred to in short as write-back) may refer to a message from a cache agent (CA) to a home agent (HA), e.g., due to an internal event, to update a cache line including data and cache line state (e.g., when the CA changes the cache state from modified to clean or invalid). An eviction message (sometimes referred to in short as eviction) may refer to a message from a CA to another memory agent (a HA or a CA) when invalidating a cache line, e.g., due to an internal event. A snoop response may refer to a message from a CA to another memory agent (a HA or a CA) when changing the state of a cache line, e.g., due to an external event or a snoop request from the other memory agent. Considering the difference in message classes, the write-back and eviction messages may be classified herein as non-snoop messages (note that a non-snoop message herein cannot be a cache line request).

In a coherence protocol, non-snoop messages including write-back and eviction may be treated as special requests. One of the properties is in the order in which the non-snoop messages are handled with respect to other messages. To comply with the principle of cache coherence, different requests should be processed in different orders. For example, if a cache line request following a write-back or eviction has the same target cache line address and same sender, they may need to behave as if the delivery ordering is preserved. Otherwise, the cache line request may have priority over the write-back or the eviction, since the cache line request may reduce the response latency of the request. A commonly seen solution to preserve the cache line request to write-back/eviction ordering is to use the same resources, such as a routing channel, for them and to enforce the ordering for messages within this channel if they have the same sender and target address. To simplify the implementation, sometimes the ordering may be enforced tighter than necessary.

The above solution may lead to the issue of deadlock. Suppose, for example, that a cache line request is first sent from a CA to a HA, and a volunteer write-back is then sent from the same CA to the same HA. According to a delivery order, the HA should process the cache line request first and then the write-back. Further, suppose that the cache line request requires the result of the write-back before the cache line request can be processed by the HA. However, if the HA has limited resources (e.g., memory space and/or bandwidth), the HA cannot process the write-back to get the required result, thus leading to a deadlock.

To avoid deadlock, some coherence protocols may pre-allocate the HA with a large amount of resources, such as a large buffer size and/or a large bandwidth, such that all write-back messages received by the HA will be able to be processed. For instance, if the HA has been read 100 times previously, there is a maximum of 100 write-backs or evictions to be received by the HA. In this case, the HA can be pre-allocated with enough resources to simultaneously process 200 operations (including 100 cache line requests and 100 write-backs or evictions). Although the deadlock can be avoided using this solution, the solution may require a large amount of resources (e.g., buffer size and/or bandwidth), which may raise system cost. Another approach to avoid deadlock may be to implement end-to-end flow control, such as having complicated sending/receiver handshaking mechanisms to restrict the number of outstanding requests at any time. Such as a solution may increase system complexity due to the handshaking mechanisms. Sometimes pre-allocation of resources and end-to-end flow control may be implemented together, but it still does not solve the deadlock issue without raising system cost or complexity.

Disclosed herein are apparatuses, systems, protocols, and methods for simplified and improved handling of cache write-back and cache eviction notice messages in a cache coherence system. According to an embodiment disclosed herein, a cache write-back or cache eviction message may be treated with the same channel and priority as a snoop response instead of being treated as a read or write request. This procedure may transmit write-back and eviction messages via a communication channel assigned to snoop responses and grant them ordering priorities that best fit their needs. The unification of the write-back and eviction messages with the snoop response may simplify the approach to avoid deadlock, thereby resulting in improved system performance, simplified implementation, and reduced cost. When handling a transaction comprising a write-back or eviction message between a source and a destination, a disclosed handling method may also eliminate the handshake procedure, which may reduce packet traffic and latency.

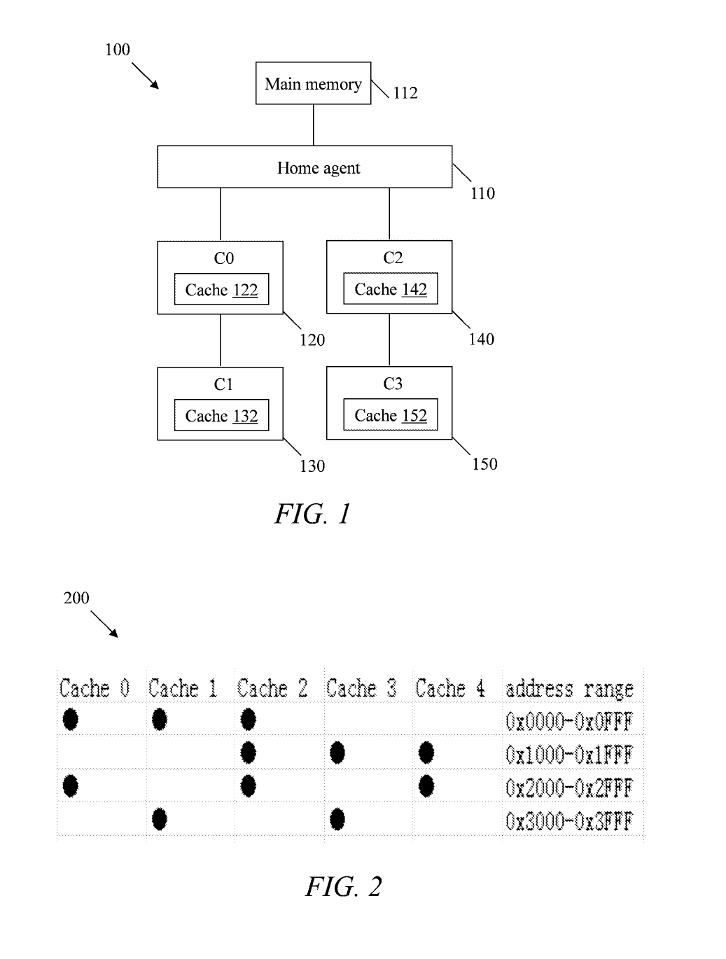

FIG. 1 illustrates an embodiment of a memory system 100, in which disclosed coherence protocols may be implemented. As shown in FIG. 1, the memory system 100 may be part of a computer system and may comprise a HA 110 and a plurality of CAs, including a CA 120 (also denoted as C0), a CA 130 (also denoted as C1), a CA 140 (also denoted as C2), and a CA 150 (also denoted as C3). The HA 110 may comprise a main memory 112 or include a memory controller that is able to access the main memory 112. Each of the CAs 120, 130, 140, and 150 may comprise or have access to each of cache memories (in short as cache) 122, 132, 142, and 152. Although shown as a main memory for illustrative purposes, the memory 112 may be any suitable type of memory or memory component, as long as it corresponds to a higher hierarchical level compared to the cache memories 122, 132, 142, and 152, each of which may also be any suitable type of memory or memory component. Examplary memory types may include, but are not limited to, integrated on-chip cache memory (i.e., cache memories integrated within a same die, e.g., level 1 (L1), level 2 (L2), or level 3 (L3) caches), memories on separate computer chips, magnetic storage devices, optical storage devices, and any other types of memory storage devices, and combinations thereof. For instance, the lower-level memory 122 may be a level 1 cache, while the higher-level memory 112 may be a level 2 or level 3 cache.

It should be understood that CA and HA (generally referred to as memory agents) are relative terms and not bound to any particular level of cache or memory. For example, the HA on a lower level may be a CA on a higher-level, while a CA on a higher level may be a HA on a lower level. A memory agent, which may be a CA or a HA, may be implemented as any memory controller or manager. In addition, depending on the application, the topology of the memory system 100 may take various forms. For example, there may be a point-to-point connection between any two of the agents. The CAs 120-150 may be coupled to one another and to the HA 110. Alternatively, some of the CAs may be directly connected to the HA 110, while other CAs may be indirectly coupled to the HA 110 through other CA(s). It should be understood that the memory system 100 may function in concert with other components of the computer system, such as multi-core processor, input/output (I/O) device, etc.

FIG. 2 illustrates an embodiment of a coherence domain implementation 200. Specifically, a coherence domain may be configured prior to the initiation of a task and removed once the task is completed. A coherence domain may be limited to a particular address range and may be mapped to a specific memory or memories, such as any of the caches 122, 132, 142, and 152. As a result, data to be stored in a given address range may only be stored in the caches that are mapped to the range in the coherence domain. The reconfiguration of the coherence domain before or after a task may allow a system to designate components that may store a given data set while providing a consistent storage address scheme for higher level memory and processes. Suppose, as shown in FIG. 2, that a system comprises five caches denoted as Cache 0 to Cache 4. Further, suppose that the system comprises address ranges of 0x0000-0x0FFF, 0x1000-0x1FFF, 0x2000-0x2FFF, and 0x3000-0x3FFF (hexadecimal representation). A first coherence domain may map address range 0x0000-0x0FFF to Caches 0-2, while a second coherence domain may map address range 0x1000-0x1FFF to Caches 2-4. Likewise, a third and fourth coherence domain may map address ranges 0x2000-0x2FFF and 0x3000-0x3FFF to Caches 0, 2, and 4 and Caches 1 and 3, respectively. Each coherence domain can be reconfigured to map to different caches at the beginning of a process, the end of a process, or as needed for a given application.

Different from a cache line request (e.g., read or write request), which may require a subsequent snoop procedure, a write-back message or an eviction message may not require any subsequent snoop procedure. A completion response and an acknowledgement may be sent after the write-back or eviction without a snoop. In a coherence protocol disclosed herein, a write-back message and an eviction message may be treated as special requests, that is, treated differently from cache line requests. Specifically, the write-back and eviction may be considered as if they were snoop responses for system resource and policy (e.g., ordering priority, transmission channel) purposes.

A write-back or eviction message may be initiated due to an external event. For example, a read or write request sent by a first CA to a HA may prompt the HA to get a write-back or eviction from a second CA as part of a snoop response. Alternatively, a write-back or eviction message may be initiated due to an internal event. For example, a first CA may send a volunteer write-back or eviction message to the HA, e.g., as part of a replacement notice, without responding to any snoop request. Both the external and internal event scenarios are further described below.

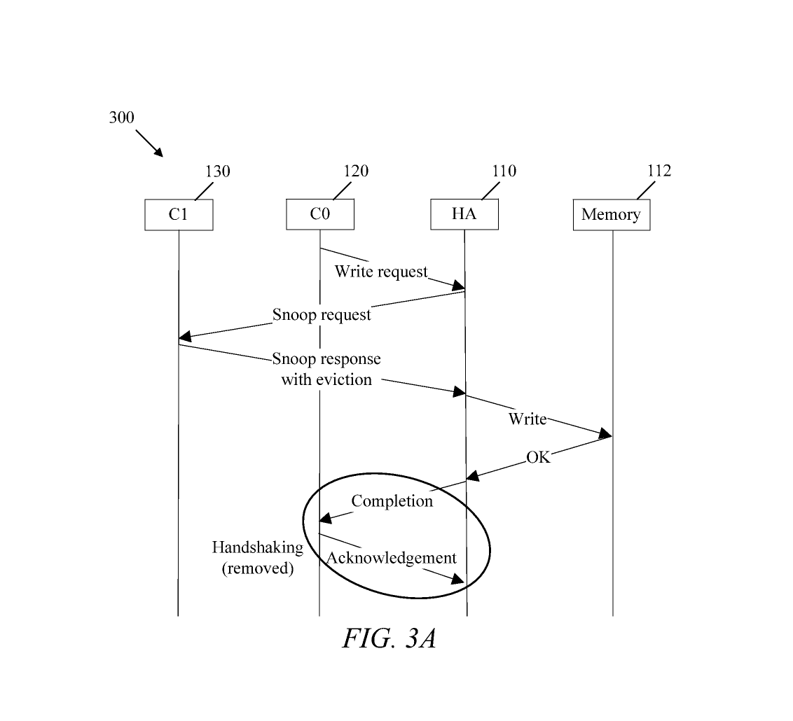

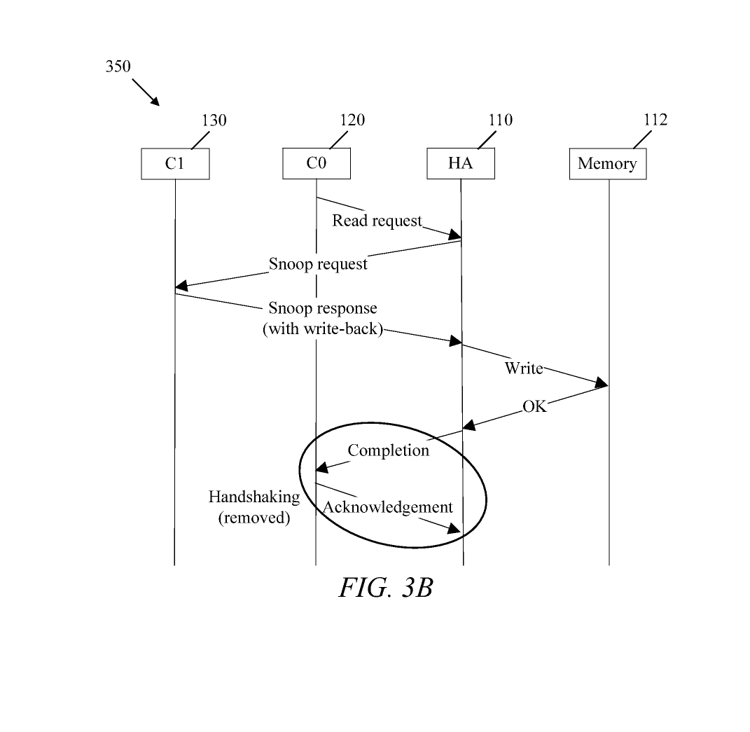

FIG. 3A illustrates an embodiment of a cache coherent write transaction 300. The protocol may be employed between the HA 110, the CA 120, the CA 130, and the main memory 112. These components may reside on a single processor or a processor cluster, and may be associated with L1 cache, L2 cache, and/or L3 cache depending on the implementation.

As shown in FIG. 3A, in the event of a write miss in a cache line managed by the CA 120, a write request may be sent from the CA 120 to the HA 110 to write data at a certain memory location or address. The HA 110 may keep a directory of all cache lines in the caches, thus the HA 110 may be aware of any cache(s) that has checked out data from the corresponding memory address. Accordingly, upon receiving the write request, the HA 110 may send a snoop request (sometimes referred to simply as a snoop) to the CA 130 (also any other CA that has checked out the data), wherein a copy of the data may be stored. The snoop request may contain instructions for the CA 130 to evict or invalidate any data stored in the corresponding cache line. The CA 130 may then send back to the HA 110 a snoop response comprising an eviction message, which indicates that the cache line in the CA 130 has been changed to an invalid state and that any data in the cache line is obsolete. In this case, the eviction message is initiated due to an external event. Since the eviction message is part of the snoop response, a snoop response channel may be used for the transmission of the eviction message.

After receiving the snoop response from the CA 130, the HA 110 may grant the outstanding write request by writing in the main memory 112. Then, the main memory 112 may confirm the write with an OK message. In a conventional transaction, the HA 110 may further send a completion message back to the CA 120, and the CA 120 may respond with an acknowledge back to the HA 110. The transaction 300 ends when the HA 110 receives the acknowledgement. In comparison, according to an embodiment disclosed herein, the handshaking procedure, including completion and acknowledgment messages exchanged between the HA 110 and the CA 130, is removed or eliminated from the transaction. The handshake procedure in the transaction 300 can be removed since it is communicated between the HA 110 and the CA 120, thus the handshake procedure is not intended for the CA 130, which issued the eviction message. In fact, a snoop procedure including snoop request and snoop response does not require any subsequent handshake procedure. Eliminating the handshake between the HA 110 and the CA 120 may reduce packet traffic and latency, which in turn improves system performance.

FIG. 3B illustrates an embodiment of a cache coherent read transaction 350. A person of ordinary skill in the art will recognize similarities between the transaction 350 and the transaction 300 described previously, thus the following description mainly focuses on aspects not yet covered. As shown in FIG. 3B, in the event of a data read miss in a cache managed by the CA 120, a read request may be sent from the CA 120 to the HA 110 to read data at a certain address(s). The HA 110 may keep a directory of all caches, thus the HA 110 may be aware of any cache(s) that has checked out the requested data. Accordingly, upon receiving the read request, the HA 110 may send a snoop request to the CA 130 (also any other CA that has checked out the data), wherein a copy of the data is stored. The snoop request may contain instructions for the CA 130 to return an updated value of the data, if any, to the HA 110. The CA 130 may then send a snoop response back to the HA 110, and change its cache line state to clean or exclusive. The snoop response may comprise a write-back message with updated data (if the corresponding cache line in the CA 130 is dirty) or no write-back message (if the cache line in the CA 130 is clean). In this case, the write-back message is initiated due to an external event. Since the write-back message is part of the snoop response, a snoop response channel may be used for the transmission of the write-back message.

After receiving the snoop response from the CA 130, the HA 110 may update data by writing the corresponding address in the main memory 112 if the snoop response has a write-back; then, the main memory 112 may confirm the update with an OK message. The updated data in the main memory 112 may be sent by the HA 110 to the CA 120 by a read response message (not shown in FIG. 3). In prior art, after sending the read response, the HA 110 may further send another completion message to the CA 120. The CA 120 may send an acknowledge back to the HA 110, upon the reception of which the transaction concludes. In an embodiment disclosed herein, the handshaking procedure, including sending/receiving of completion and acknowledgment messages, is removed from the transaction. The handshake procedure can be removed since it is communicated between the HA 110 and the CA 120, thus the handshake procedure is not intended for the CA 130, which issued the write-back message.

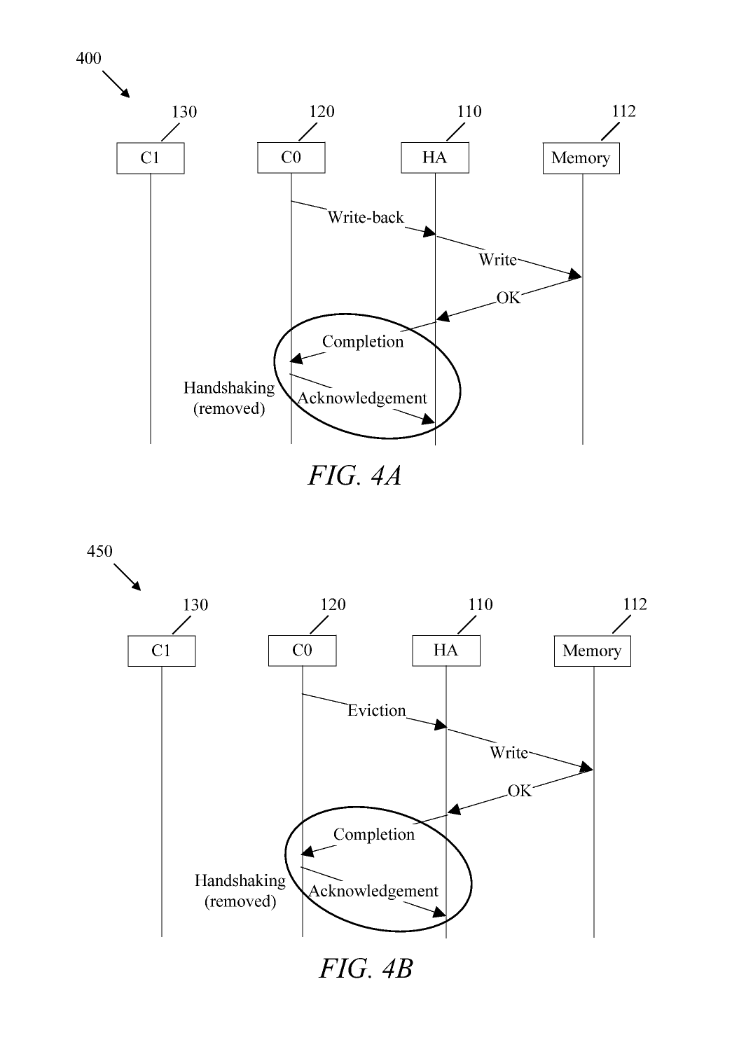

FIG. 4A illustrates an embodiment of a cache coherent write-back transaction 400. A person of ordinary skill in the art will recognize similarities between the transaction 400 and transactions described previously, thus the following description mainly focuses on aspects not yet covered. As shown in FIG. 4A, a volunteer write-back message may be sent from the CA 120 to the HA 110, e.g., as part of a replacement notice, without responding to any third-party cache line request. The write-back message may comprise updated data stored in the CA 120 that needs to be returned to the HA 110. In a conventional approach, unless a write-back is part of a snoop response (e.g., the write-back in transaction 350 is part of a snoop response, while the write-back in transaction 400 is not part of a snoop response), the write-back may be treated the same as or similar to a cache line request (read or write request). In comparison, according to an embodiment disclosed herein, the write-back uses system resources and follows policy reserved for snoop responses, regardless of whether it is part of a snoop response. In an embodiment, a snoop response channel instead of a request channel may be used for the transmission of the write-back message in the transaction 400. Advantages of such treatment will be described later.

Recall that the write-back message does not require any subsequent snoop procedure, thus, in the transaction 400, the HA 110 may directly proceed to writing the updated data in the memory 112. The memory 112 may confirm the write with an OK message. In a conventional approach, the HA 110 may further send a completion message back to the CA 120, and the CA 120 may respond with an acknowledge to the HA 110. The transaction ends when the HA 110 receives the acknowledgement. In comparison, according to an embodiment disclosed herein, the handshaking procedure, including completion and acknowledgment messages exchanged between the HA 110 and the CA 120, is eliminated or removed from the transaction 400. The handshake procedure in the transaction 300 can be removed since the write-back procedure has already been completed before the handshake.

FIG. 4B illustrates an embodiment of a cache coherent eviction transaction 450. A person of ordinary skill in the art will recognize similarities between the transaction 450 and transactions described previously, thus the following description mainly focuses on aspects not yet covered. As shown in FIG. 4B, a volunteer eviction message may be sent from the CA 120 to the HA 110 without responding to any third-party cache line request, e.g., when a cache line in the CA 120 needs to be invalidated to make room for new data. In a conventional approach, unless an eviction is part of a snoop response (e.g., the eviction in transaction 300 is part of a snoop response, while the eviction in transaction 450 is not part of a snoop response), the eviction may be treated the same as or similar to a cache line request (read or write request). In comparison, according to an embodiment disclosed herein, the eviction uses system resources and follows policy reserved for snoop responses, regardless of whether the eviction is part of a snoop response. In an embodiment, a snoop response channel instead of a request channel may be used for the transmission of the eviction message in the transaction 450. Advantages of such treatment will be described later.

Recall that the eviction message does not require any subsequent snoop procedure, thus, in the transaction 450, the HA 110 does not need to perform such procedure. In a conventional approach, the HA 110 may further send a completion message back to the CA 120, and the CA 120 may respond with an acknowledge to the HA 110. The transaction ends when the HA 110 receives the acknowledgement. In comparison, according to an embodiment disclosed herein, the handshaking procedure, including completion and acknowledgment messages exchanged between the HA 110 and the CA 120, is eliminated from the transaction 450. The handshake procedure in the transaction 300 can be removed since the eviction procedure has already been completed before the handshake.

Although transactions described above (e.g., transactions 300, 350, 400, and 450) are between a HA and one or more CAs, it should be understood that the same principles disclosed herein may be used for transactions between multiple CAs. Any memory agent (CA or HA) may be the source or sender of a transaction, and any other memory agent may be the destination or receiver of the transaction. For example, elimination of the handshake procedure may be implemented between any sender and receiver to reduce packet traffic and latency. Further, the transactions described above may be simplified illustrations of an actual transaction, thus additional messages or information may be exchanged between the multiple agents.

As shown previously, a memory system may comprise a plurality of agents configured to communicate with one another through cache coherence protocols. Since multiple messages may be sent from one source to multiple destinations, or sent from one source to the same destination multiple times, or from multiple sources to the same destination, ordering conflict can arise and thus needs to be addressed via suitable order policies, which are described next.

When there are multiple read or write requests that target the same address, the ordering between these operations or transactions should be handled consistently. The ordering policy may follow either source ordering or destination ordering. The source ordering and the destination ordering may not be the same, because the source and destination may prioritize operations differently. For example, a source may consider a read request more important than a write-back message (because the source needs to read data but may care less about delivery of the write-back message), while a destination may consider the write-back message more important than the read request (because the destination needs to update its data via the write-back message but may care less about a data read from the source). A source ordering (or delivery ordering) policy may enforce the observed consistency according to an order in which the operations are initiated at the source. Alternatively, a destination ordering (or completion ordering) policy may enforce the observed consistency according to an order in which the operations are served by the destination. There may be other variations to deal with the difference between source and destination orderings, as a person of ordinary skill in the art will recognize.

In a coherence protocol disclosed herein, write-back and eviction are special requests or operations, thus their ordering should be handled differently from cache line requests. In an embodiment, the write-back and eviction may take higher priority over any other outstanding read or write requests initiated from a different source(s) but targeting the same destination. Accordingly, sometimes the write-back and eviction may be reordered with respect to other cache line requests targeting the same destination, either on the way towards the destination or at the destination, so that they are set up to be completed before the other cache line requests. To an extent, the treatment of a write-back or eviction may be the same with a snoop response, which may also take priority over an outstanding read or write request targeting the same destination. In this case, the write-back and eviction messages are treated as if they were self-initiated snoop responses.

When a write-back or eviction collides with a cache line request initiated from the same source and targeting the same destination, or when a write-back or eviction collides with another snoop response (regardless of whether from the same source), the original ordering policy should be preserved. That is, no reordering may be performed.

In some embodiments, the handling of write-back and eviction messages may follow some or all of the following rules. According to Rule 1, the transmission of write-back and eviction messages may use a communication channel that is different from a communication channel used for cache line requests. The communication channels may be different physical channels (sets of wires) or virtual channels. For example, the transmission of a write-back or eviction message may use a snoop response channel instead of a cache line request channel. In this case, since different resources are used to handle the write-back/eviction and cache line requests, the potential issue of deadlock may be effectively eliminated. Specifically, a number of write-back and/or eviction messages are currently being processed by a HA may not affect the HA's capability to process cache line requests. In other words, write-back and cache line requests are not in the same queue or line anymore. Accordingly, this disclosure may not require any form of end-to-end buffering flow control to avoid deadlock, which may be costly in area and performance, and usually not scalable.

According to Rule 2, every message (including write-back, eviction, and regular snoop response) in the snoop response channel should be able to be consumed by a destination, such as a HA. Rule 2 may be implemented using various approaches. In a first examplary approach, every message in the snoop response channel is a complete message comprising both command/instruction and data. In other words, every message is a non-split message. In a second examplary approach, the HA may be pre-allocated with certain storage space and/or bandwidth such that it may guarantee sufficient space and/or bandwidth to handle all snoop response(s) for every snoop request issued by the HA. Since the deadlock issue has been solved, the pre-allocation of resource in this case may require relatively small amount of system overhead.

According to Rule 3, if a snoop response after a write-back or eviction shares the same source and target addresses, the source ordering should be preserved. For example, when a snoop response and a write-back/eviction regarding the same cache line in a cache (managed by a CA) and targeting the same memory address in a main memory (managed by a HA) are sent from the CA to the HA, the snoop response and the writeback/eviction messages may be processed by the HA following an ordering in which the snoop response and the writeback/eviction messages are initiated by the CA. According to Rule 4, if a cache line request after a write-back or eviction ordering shares the same source and target address, there may be several ordering options. For example, Option 1 is back-snooping. This option may enforce destination ordering instead of source ordering. In an embodiment, if the HA receives a cache line request and decides or determines that there may be a write-back or eviction from the same source running behind the cache line request, the HA may issue a snoop request to the source (may also issue other snoop requests to other CAs). In this case, the cache line request may need to wait for all snoop responses from all CAs to be received and processed by the HA. The HA may make the decision according to a cache snoop filter, or the HA may simply broadcast snoop requests to all CAs coupled to the HA. In use, any processing scheme may be used by the HA as long as responding to the cache line request takes into account the effect of the snoop responses (e.g., data updated according to a snoop response containing most updated data, or directory updated after receiving a snoop response comprising an eviction message) For another example, Option 2 is to preserve the source ordering. This option may enforce the source ordering, e.g., when a cache line request trails a write-back or eviction and they have the same source and destination. Further, Option 2 may enforce the ordering across the request channel and the snoop response channel.

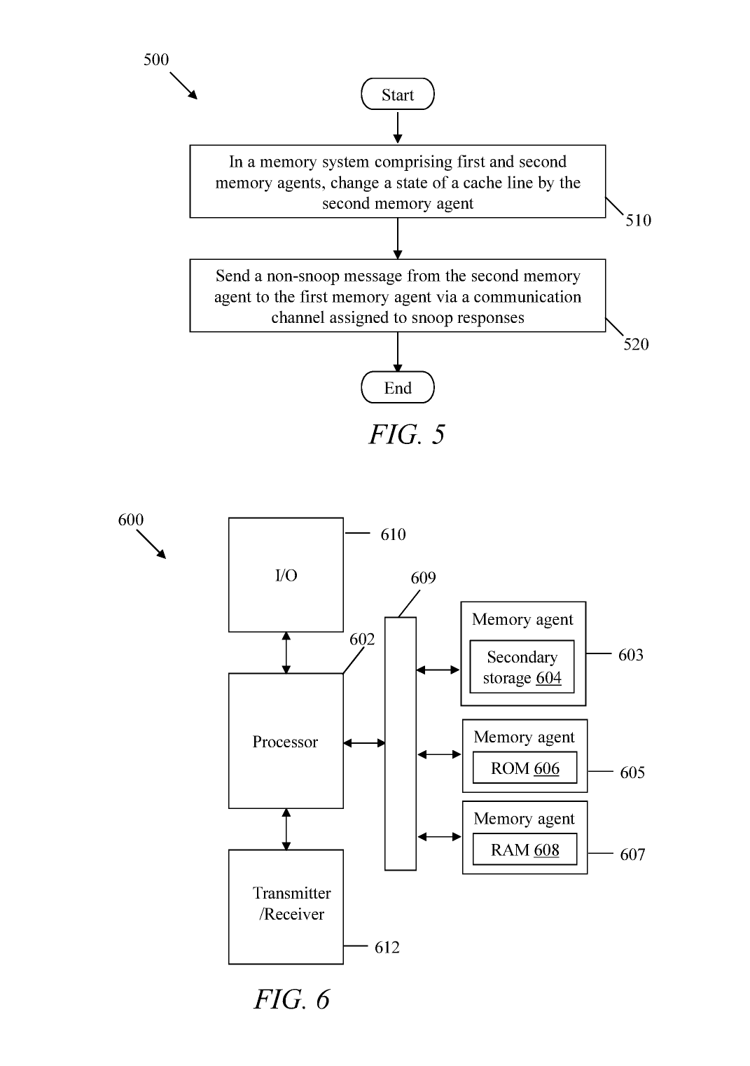

FIG. 5 illustrates an embodiment of a cache-coherent message handling method 500, which may be implemented by a computer system comprising a memory system (e.g., the memory system 100). Suppose, for illustrative purposes, the memory system comprises a first memory agent and a second memory agent. Recall that a memory agent herein may refer to a HA or a CA, thus we may further suppose that the first memory agent is a HA or CA, while the second memory agent is a CA having access to a cache comprising a cache line. The method 500 starts in step 510, in which the second memory agent changes a state of the cache line. In step 520, in which the second memory agent sends a non-snoop message to the first memory agent via a communication channel assigned to snoop responses, wherein the non-snoop message informs the first memory agent of the state change of the cache line in step 510. Note that a transaction shown by the method 500 does not include any handshake (completion response and/or acknowledgment) between the first and second memory agents.

Depending on the transaction, the steps in the method 500 may mean a number of different things. In a first example, the first memory agent is a HA and the second memory agent is a CA. In step 510, the state of the cache line may be changed from dirty (e.g., modified) to clean or invalid, in which case the non-snoop message in step 520 is a write-back message comprising data stored in the dirty cache line. In a second example, the first memory agent is a HA or CA, while the second memory agent is a CA. In step 510, the state of the cache line may be changed from clean to invalid, in which case the non-snoop message in step 520 is an eviction message.

In use, since multiple transactions may occur between the first and second memory agents (may also involve additional memory agents in the memory system), a person of ordinary skill in the art will understand that additional steps may be added to the method 500 as appropriate. For example, cache line requests (read or write) may be communicated between the first and second memory agent via an additional communication channel assigned for cache line requests. Source ordering or destination ordering policy may be enforced by the first memory agent in processing the multiple messages or requests.

The schemes described above may be implemented on a network component, such as a computer or network component with sufficient processing power, memory resources, and network throughput capability to handle the necessary workload placed upon it. FIG. 6 illustrates an embodiment of a network component or computer system 600 suitable for implementing one or more embodiments of the methods disclosed herein, such as the write transaction 300, the read transaction 350, the write-back transaction 400, the eviction transaction 450, and the message handling method 500. Further, components in the computer system 600 may be configured to implement any of the apparatuses described herein, such as the memory system 100, the coherence domain implementation 200.

The computer system 600 includes a processor 602 that is in communication with memory devices including a memory agent 603, a memory agent 605, a memory agent 607, input/output (I/O) devices 610, and transmitter/receiver 612. Although illustrated as a single processor, the processor 602 is not so limited and may comprise multiple processors. The processor 602 may be implemented as one or more central processor unit (CPU) chips, cores (e.g., a multi-core processor), field-programmable gate arrays (FPGAs), application specific integrated circuits (ASICs), and/or digital signal processors (DSPs), and/or may be part of one or more ASICs. The processor 602 may be configured to implement any of the schemes described herein, including the write transaction 300, the read transaction 350, the write-back transaction 400, the eviction transaction 450, and the message handling method 500. The processor 602 may be implemented using hardware or a combination of hardware and software.

Each of the processor 602 and the memory agents 603, 605, and 607 may communicate with one another via a bus 609. The bus 609 may comprise multiple communication channels, some of which are assigned to snoop responses and some of which are assigned to cache line requests. The memory agent 603 may be a HA comprising or having access to a secondary storage 604. The memory agent 605 may be a CA comprising or having access to a read only memory (ROM) 606. The memory agent 605 may be a CA comprising or having access to a random access memory (RAM) 608. The secondary storage 604 is typically comprised of one or more disk drives or tape drives and is used for non-volatile storage of data and as an over-flow data storage device if the RAM 608 is not large enough to hold all working data. The secondary storage 604 may be one or more flash memories. The secondary storage 604 may be used to store programs that are loaded into the RAM 608 when such programs are selected for execution. The ROM 606 is used to store instructions and perhaps data that are read during program execution. The ROM 606 is a non-volatile memory device that typically has a small memory capacity relative to the larger memory capacity of the secondary storage 604. The RAM 608 is used to store volatile data and perhaps to store instructions. Access to both the ROM 606 and the RAM 608 is typically faster than to the secondary storage 604.

The transmitter/receiver 612 may serve as an output and/or input device of the computer system 600. For example, if the transmitter/receiver 612 is acting as a transmitter, it may transmit data out of the computer system 600. If the transmitter/receiver 612 is acting as a receiver, it may receive data into the computer system 600. The transmitter/receiver 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The transmitter/receiver 612 may enable the processor 602 to communicate with an Internet or one or more intranets. I/O devices 610 may include a video monitor, liquid crystal display (LCD), touch screen display, or other type of display. I/O devices 610 may also include one or more keyboards, mice, or track balls, or other well-known input devices.

It is understood that by programming and/or loading executable instructions onto the computer system 600, at least one of the processor 602, the secondary storage 604, the RAM 608, and the ROM 606 are changed, transforming the computer system 600 in part into a particular machine or apparatus (e.g., a server system having the novel functionality taught by the present disclosure). The executable instructions may be stored on the secondary storage 604, the ROM 606, and/or the RAM 608 and loaded into the processor 602 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented by a computer system comprising a first memory agent and a second memory agent coupled to the first memory agent, wherein the second memory agent has access to a cache comprising a cache line, the method comprising:
changing a state of the cache line by the second memory agent; and
sending a non-snoop message from the second memory agent to the first memory agent via a communication channel assigned to snoop responses, wherein the non-snoop message informs the first memory agent of the state change of the cache line.

2. The method of claim 1, wherein the first memory agent is a home agent and the second memory agent is a cache agent, wherein the state of the cache line is changed from dirty to clean or invalid, and wherein the non-snoop message is a write-back message comprising data stored in the dirty cache line.

3. The method of claim 1, wherein the first memory agent is a home agent or a first cache agent, and the second memory agent is a second cache agent, wherein the state of the cache line is changed from clean to invalid, and wherein the non-snoop message is an eviction message.

4. The method of claim 1, wherein, in a transaction comprising the sending of the non-snoop message, no handshake is performed between the first and second memory agents following the non-snoop message.

5. The method of claim 4, further comprising:
sending, from the second memory agent to the first memory agent via the communication channel, a snoop response in another transaction regarding the cache line; and
processing, by the first memory agent, the non-snoop message and the snoop response following an ordering in which the non-snoop message and the snoop response are initiated by the second memory agent.

6. The method of claim 4, further comprising:
receiving, by the first memory agent, a cache line request regarding the cache line sent from another memory agent via an additional communication channel that is assigned for cache line requests; and
processing, by the first memory agent, the non-snoop message prior to the cache line request regardless of the order in which the non-snoop message and the cache line request are received by the first memory agent.

7. The method of claim 4, further comprising:
sending a cache line request regarding the cache line from the second memory agent to the first memory agent via an additional communication channel that is assigned for cache line requests; and
processing, by the first memory agent, the non-snoop message and the cache line request following an ordering in which the non-snoop message and the cache line request are initiated by the second memory agent.

8. An apparatus comprising:
a first memory agent; and
a second memory agent coupled to the first memory agent and configured to:
change a state of a cache line accessible to the second memory agent; and
send a non-snoop message to the first memory agent via a communication channel assigned to snoop responses, wherein the non-snoop message informs the first memory agent of the state change of the cache line.

9. The apparatus of claim 8, wherein the first memory agent is a home agent and the second memory agent is a cache agent, wherein the state of the cache line is changed from dirty to clean or invalid, and wherein the non-snoop message is a write-back message comprising data stored in the dirty cache line.

10. The apparatus of claim 8, wherein the state of the cache line is changed from clean to invalid, and wherein the non-snoop message is an eviction message.

11. The apparatus of claim 8, wherein, in a transaction comprising the sending of the non-snoop message, no handshake is performed between the first and second memory agents following the write-back or eviction message.

12. The apparatus of claim 11, wherein the first memory agent is a home agent (HA) configured to:
receive a plurality of messages, including snoop responses and the non-snoop message, from the communication channel, wherein each of the plurality of messages contains all information needed for processing by the HA; and
process each of the plurality of messages.

13. The apparatus of claim 11, wherein the first memory agent is a home agent (HA) configured to:
receive a plurality of messages, including snoop responses and the non-snoop message, from the communication channel; and
process each of the plurality of messages,
wherein the HA is pre-allocated with sufficient resources including storage space and bandwidth such that processing each of the plurality of messages is executed by the HA without delay.

14. The apparatus of claim 13, wherein the HA is further configured to:
receive read requests and write requests regarding the cache line sent from the second memory agent or any other cache agent via an additional communication channel that is assigned for the read requests and the write requests; and
process each of the read requests and the write requests following a first order, and wherein processing the plurality of messages follows a second order that is independent of the first order.

15. A method implemented by a computer system comprising a home agent (HA) and at least one cache agent (CA), wherein the at least one CA comprises a CA having access to a cache comprising a cache line, the method comprising:
changing a state of the cache line by the CA; and
sending either a write-back message comprising data stored in the cache line or an eviction message from the CA to the HA, wherein, in a transaction comprising the state change and sending the write-back or eviction message, no handshake is performed between the HA and the CA following the write-back or eviction message.

16. The method of claim 15, wherein the handshake comprises exchange of completion and acknowledgement messages, and wherein no exchange of the completion and acknowledgement messages is performed between the HA and the CA following the write-back or eviction message.

17. The method of claim 15, wherein the write-back or eviction message is a volunteer message initiated by the CA without responding to any prior cache line request sent from any of the at least one CA to the HA in the transaction, wherein sending the write-back or eviction message uses a communication channel assigned to snoop responses.

18. The method of claim 15, further comprising, prior to sending the write-back or eviction message,
sending a cache line request from the CA to the HA via an additional communication channel that is assigned for cache line requests;
sending a snoop request from the HA to the CA in response to the cache line request; and
sending a snoop response from the CA to the HA in response to the snoop request via the communication channel, wherein the write-back or eviction message is part of the snoop response.

19. The method of claim 18, further comprising processing, by the HA, the write-back or eviction message prior to the cache line request regardless of the order in which the write-back or eviction message and the cache line request are received by the HA.

20. The method of claim 19, wherein either the write-back message corresponds to the cache line request being a read request or the eviction message corresponds to the cache line request being a write request.
